(19) United States
(12) Patent Application Publication
(10) Pub. No.: US 2025/0021466 A1
(43) Pub. Date: Jan. 16, 2025

(54) SYSTEMS AND METHODS FOR STORAGE AND EVALUATION OF SOURCE CODE

(71) Applicant: Stephen GRAY, Cae Siriol (GB)

(72) Inventor: Stephen GRAY, Cae Siriol (GB)

(21) Appl. No.: 18/775,660

(22) Filed: Jul. 17, 2024

Related U.S. Application Data
(63) Continuation of application No. 18/770,145, filed on Jul. 11, 2024.
(60) Provisional application No. 63/513,104, filed on Jul. 11, 2023.
(60) Provisional application No. 63/514,030, filed on Jul. 17, 2023.

(51) Int. Cl. G06F 11/36; G06F 16/332; G10L 15/22; H04L 51/02

(52) U.S. Cl. CPC G06F 11/3616; G06F 16/3329; G10L 15/22; H04L 51/02

(57) ABSTRACT

Systems and methods for evaluating the security and vulnerabilities of source code are disclosed. A system in accordance with the present disclosure comprises a processor in communication with a memory storing computer-executable instructions. The processor is configured to receive source code from a database and scan the source code and determine if the source code contains at least one of one or more issues or one or more warnings. The processor is further configured to determine, based on the scan, a security score for the source code and cause to be displayed, on a user interface, an interactive dashboard displaying an indication representing the security score for the source code and an explanation of the security score.

### CROSS-REFERENCE TO REPLATED APPLICATION

This application is a continuation of U.S. application Ser. No. 18/770,145, filed Jul. 11, 2024, entitled “SYSTEMS AND METHODS FOR STORAGE AND EVALUATION OF SOURCE CODE”, which claims the benefit of U.S. Provisional Application No. 63/513,104, filed Jul. 11, 2023, entitled “METHOD AND SYSTEM FOR CODE REGISTRY AND RETRIEVAL” and U.S. Provisional Application No. 63/514,030, filed Jul. 17, 2023, entitled “SYSTEMS AND METHODS FOR CODE REPLICATION AND VALUATION”, which are hereby incorporated by reference in their entirety.

### FIELD OF THE INVENTION

The present invention relates to systems and methods for storing and evaluating software code, algorithms, or other intellectual property (IP).

### BACKGROUND

Currently, if you are the founder of a software company, an investor, an IP attorney, a mergers and acquisitions advisor or buyer, and/or any other party with an interest software code, algorithms, and/or other proprietary IP, there is no system or method for accurately, efficiently, and succinctly obtaining the following information: (i) where is the code and how can it be accessed; (ii) what is in the code, how was it written, how complex and unique is it, how many man hours would it take to recreate it; and (iii) what is the value of the IP. Currently, to obtain this information, one would have to reach out to one or more personnel (e.g., chief technology officer, engineers, etc.), interface with multiple third-party systems or cloud service providers, engage IP counsel and/or a consultant to provide an IP Audit, use a developers code service that is made for technical developer to access and analyze the code base through a third party hub written for and by them, and/or pursue other burdensome, costly, and time-consuming tasks. In some instances it may take several months or more to gather the necessary information. Even if the necessary information is able to be obtained, answers to the questions may not be clear and/or succinct. For example, there may be no way to determine a value of the IP. Currently, there is no central access point through which stakeholders can access the same information in real-time and present the information in a clear manner. Therefore, a seamless and efficient platform for storing, evaluating, replicating, and certifying computer code is highly desirable.

### BRIEF SUMMARY OF THE INVENTION

In an exemplary embodiment, systems and methods may be provided for the storage and evaluation of software code.

In one aspect, a system for evaluating security and vulnerabilities of source code is provided. The system comprises at least one memory storing computer-executable instructions and at least one processor in communication with the at least one memory. The at least one processor is configured to execute the computer-executable instructions to receive source code and scan the source code and determine if the source code contains at least one of one or more issues or one or more warnings. The processor is further configured to determine, based on the scan, a security score for the source code and cause to be displayed, on a user interface, an interactive dashboard displaying an indication representing the security score for the source code and an explanation of the security score.

In another aspect, a computer-based method for the storage and evaluation of source code is provided. The computer-based method is implemented using a system including a computing device including at least one processor communicatively coupled to a memory device. The computer-based method comprises receiving source code and scanning the source code and determining if the source code contains at least one of one or more issues or one or more warnings. The computer-based method further comprises determining, based on the scan, a security score for the source code and causing to be displayed, on a user interface, an interactive dashboard displaying an indication representing the security score for the source code and an explanation of the security score.

In yet another aspect, at least one non-transitory computer-readable storage medium having computer-executable instructions embodied thereon is provided. The computer-executable instructions, when executed by at least one processor, cause the at least one processor to receive source code and scan the source code and determine if the source code contains at least one of one or more issues or one or more warnings. The instructions further cause the at least one processor to determine, based on the scan, a security score for the source code and cause to be displayed, on a user interface, an interactive dashboard displaying an indication representing the security score for the source code and an explanation of the security score.

Advantages will become more apparent to those skilled in the art from the following description of the preferred embodiments which have been shown and described by way of illustration. As will be realized, the present embodiments may be capable of other and different embodiments, and their details are capable of modification in various respects Accordingly, the drawings and description are to be regarded as illustrative in nature and not as restrictive.

### BRIEF DESCRIPTION OF THE DRAWINGS

This disclosure is illustrated by way of example and not by way of limitation in the accompanying figure(s). The figure(s) may, alone or in combination, illustrate one or more embodiments of the disclosure. Elements illustrated in the figure(s) are not necessarily drawn to scale. Reference labels may be repeated among the figures to indicate corresponding or analogous elements.

The detailed description makes reference to the accompanying figures in which:

FIG. 1 is a block diagram of a code analysis (CA) system in accordance with an embodiment of the present disclosure.

FIG. 2 is a block diagram of an exemplary client computing device that may be used with the CA system illustrated in FIG. 1.

FIG. 3 is a block diagram of an exemplary server system that may be used with the CA system illustrated in FIG. 1.

FIG. 4 is a block diagram of a value intelligence engine in accordance with an embodiment of the present disclosure.

FIG. 5 is a flow diagram showing a valuation process in accordance with an embodiment of the present disclosure.

FIG. 6 is a block diagram of a CA architecture in accordance with an embodiment of the present disclosure.

FIG. 7 is a first user interface in accordance with an embodiment of the present disclosure.

FIG. 8 is a second user interface in accordance with an embodiment of the present disclosure.

FIG. 9 is a third user interface in accordance with an embodiment of the present disclosure.

FIG. 10 is a fourth user interface in accordance with an embodiment of the present disclosure.

FIG. 11 is a fifth user interface in accordance with an embodiment of the present disclosure.

FIG. 12 is a sixth user interface in accordance with an embodiment of the present disclosure.

FIG. 13 is a seventh user interface in accordance with an embodiment of the present disclosure.

FIG. 14 is an eighth user interface in accordance with an embodiment of the present disclosure.

### DETAILED DESCRIPTION

The figures and descriptions provided herein may have been simplified to illustrate aspects that are relevant for a clear understanding of the herein described apparatuses, systems, and methods, while eliminating, for the purpose of clarity, other aspects that may be found in typical similar devices, systems, and methods. Those of ordinary skill may thus recognize that other elements and/or operations may be desirable and/or necessary to implement the devices, systems, and methods described herein. But because such elements and operations are known in the art, and because they do not facilitate a better understanding of the present disclosure, for the sake of brevity a discussion of such elements and operations may not be provided herein. However, the present disclosure is deemed to nevertheless include all such elements, variations, and modifications to the described aspects that would be known to those of ordinary skill in the art.

Many software projects include proprietary code, algorithms, or other intellectual property a company would like to protect, especially when working with a development partner, or other third-party. Maintaining a separate, private code repository can ensure that a codebase remains confidential and secure. This prevents accidental or unauthorized sharing of proprietary information.

The present embodiments may relate to, inter alia, systems and methods for storing, replicating, and/or evaluating software code. Currently, there are no systems or methods in which an executive, third-party, or any other person with an interest in a codebase or other IP to accurately and efficiently receive information, in real-time, regarding: (i) where the code is stored and how it may be accessed; (ii) what is in the code, how was it written, how complex and unique is it, and how many man hours would it take to recreate it; and (iii) what is the value of the IP (monetary, market, or otherwise).

Currently, there is no quick, efficient, and easy way to receive this information. For example, currently one would have to reach out to one or more personnel (e.g., chief technology officer, engineers, etc.), interface with multiple third-party systems or cloud service providers, engage IP counsel and/or another consultant to provide an IP Audit, use a developers code service that is made for technical developer to access and analyze the code base through a third party hub written for and by them, and/or conduct other burdensome, costly, and time-consuming tasks. In some instances it may take several months or more to gather the necessary information. Even if the necessary information is able to be obtained, answers to the questions may not be cleanly answered. Therefore, currently, there is no central access point through which stakeholders can access the same information in real-time and present the information in a clear manner. The present invention provides a seamless and efficient platform to help store, evaluate, replicate, and certify computer code.

“Source code”, or simply “code”, as used herein, may refer generally to text that conforms to a human-readable programming language and specifies the behavior of a computer. A programmer writes code to produce a program that runs on a computer.

“Codebase”, as used herein, may refer generally to a collection of source code used to build a particular software system, application, or software component.

“Computer code replication”, as used herein, may refer generally to a process of duplicating or reproducing an entire codebase and/or sections of code within a software program. It may involve copying and pasting code snippets or entire functions to create multiple instances of the same logic in different parts of the program.

“App” as used herein, may refer generally to a software application installed and downloaded on a user computing device and executed to provide an interactive graphical user interface at the user computing device. An app associated with the computer system, as described herein, may be understood to be maintained by the computer system and/or one or more components thereof. Accordingly, a “maintaining party” of the app may be understood to be responsible for any functionality of the app and may be considered to instruct other parties/components to perform such functions via the app.

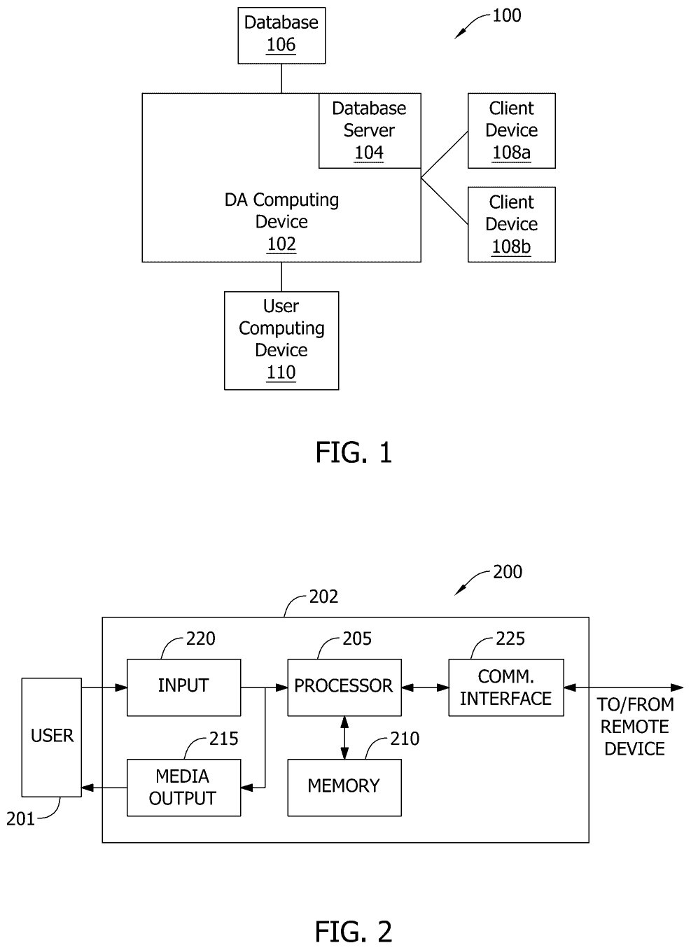

FIG. 1 depicts an exemplary code analysis (CA) computing system 100. CA computing system 100 may include a CA computing device 102 (also referred to herein as CA server or CA computer device). In one embodiment, CA computing device 102 may leverage artificial intelligence (AI) and machine learning (ML), as discussed in more detail below. CA computing device 102 may include a database server 104. Further, CA computing device 102 may be in communication with, for example, a database 106, one or more client devices 108a and 108b, and a client computing device, such as user computing device 110.

In the exemplary embodiments, client devices 108a and 108b may be computers that include a web browser or a software application, which enables the devices to access remote computer devices, such as CA computing device 102, using the Internet or another type of network. More specifically, client devices 108a and 108b may be communicatively coupled to CA computing device 102 through many interfaces including, but not limited to, at least one of the Internet, a network, such as the Internet, a local area network (LAN), a wide area network (WAN), or an integrated services digital network (ISDN), a dial-up-connection, a digital subscriber line (DSL), a cellular phone connection, and a cable modem. Client devices 108a and 108b may be any device capable of accessing the Internet including, but not limited to, a desktop computer, a laptop computer, a personal digital assistant (PDA), a cellular phone, a smartphone, a tablet, a phablet, wearable electronics, smart watch, or other web-based connectable equipment or mobile devices.

User device 110 may be a computer that includes a web browser or a software application, which enables user device 110 to access remote computer devices, such as CA computing device 102, using the Internet or other network. In some embodiments, user device 110 may be associated with, or part of a computer network associated with, a medical records company. In other embodiments, user device 110 may be associated with a third party. More specifically, user device 110 may be communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem. User device 110 may be any device capable of accessing the Internet including, but not limited to, a desktop computer, a laptop computer, a personal digital assistant (PAI), a cellular phone, a smartphone, a tablet, a phablet, wearable electronics, smart watch, or other web-based connectable equipment or mobile devices.

Database server 104 may be communicatively coupled to database 106 that stores data. In one embodiment, database 106 may include third party data or other data necessary for the analysis of the source code (e.g., wages for employees necessary for replicating the source code). In the exemplary embodiment, database 106 may be stored remotely from CA computing device 102. In some embodiments, database 106 may be decentralized. In the exemplary embodiment, a user may access database 106 and/or CA computing device 102 via client devices 108a and 108b.

FIG. 2 illustrates a block diagram 200 of an exemplary client computing device 202 that may be used with CA computing system 100 and/or CA computing device 102 (shown in FIG. 1). Client computing device 202 may be, for example, at least one of devices 108a, 108b, and 110 (all shown in FIG. 1).

Client computing device 202 may include a processor 205 for executing instructions. In some embodiments, executable instructions may be stored in a memory area 210. Processor 205 may include one or more processing units (e.g., in a multi-core configuration). Memory area 210 may be any device allowing information such as executable instructions and/or other data to be stored and retrieved. Memory area 210 may include one or more computer readable media.

In exemplary embodiments, processor 205 may include and/or be communicatively coupled to one or more modules for implementing the systems and methods described herein. For example, in one exemplary embodiment, a module may be provided for receiving data and analyzing such data. Received data may include, but is not limited to, source code and/or data necessary for analyzing the source code (e.g., employee wages for determining value of IP). Processor 205 may include or be communicatively coupled to another module for analyzing such data. For example, in one embodiment, processor 205 is communicatively coupled to an AI/ML module configured to leverage AI and ML to analyze source code.

In one or more exemplary embodiments, computing device 202 may also include at least one media output component 215 for presenting information a user 201. Media output component 215 may be any component capable of conveying information to user 201. In some embodiments, media output component 215 may include an output adapter such as a video adapter and/or an audio adapter. An output adapter may be operatively coupled to processor 205 and operatively coupled to an output device such as a display device (e.g., a liquid crystal display (LCD), a light emitting diode (LED) display, an organic light emitting diode (OLED) display, a cathode ray tube (CRT) display, an “electronic ink” display, a projected display, etc.) or an audio output device (e.g., a speaker arrangement or headphones). Media output component 215 may be configured to, for example, display an interactive dashboard showing one or more metrics regarding source code stored in the code vault and/or enabling user 201 to input queries.

Client computing device 202 may also include an input device 220 for receiving input from a user 201. Input device 220 may include, for example, a keyboard, a pointing device, a mouse, a stylus, a touch sensitive panel (e.g., a touch pad or a touch screen), a scanner, an image capturing device, or an audio input device. A single component, such as a touch screen, may function as both an output device of media output component 215 and an input device of input device 220.

Client computing device 202 may also include a communication interface 225, which can be communicatively coupled to a remote device, such as CA computing device 102, shown in FIG. 1. Communication interface 225 may include, for example, a wired or wireless network adapter or a wireless data transceiver for use with a mobile phone network (e.g., Global System for Mobile communications (GSM), 3G, 4G, or Bluetooth) or other mobile data networks (e.g., Worldwide Interoperability for Microwave Access (WIMAX)). The systems and methods disclosed herein are not limited to any certain type of short-range or long-range networks.

Stored in memory area 210 may be, for example, computer readable instructions for providing a user interface to user 201 via media output component 215 and, optionally, receiving and processing input from input device 220. A user interface may include, among other possibilities, a web browser or an application (“app”). Web browsers may enable users, such as user 201, to display and interact with media and other information typically embedded on a web page or a website.

Memory area 210 may include, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAN). The above memory types are exemplary only, and are thus not limiting as to the types of memory usable for storage of a computer program.

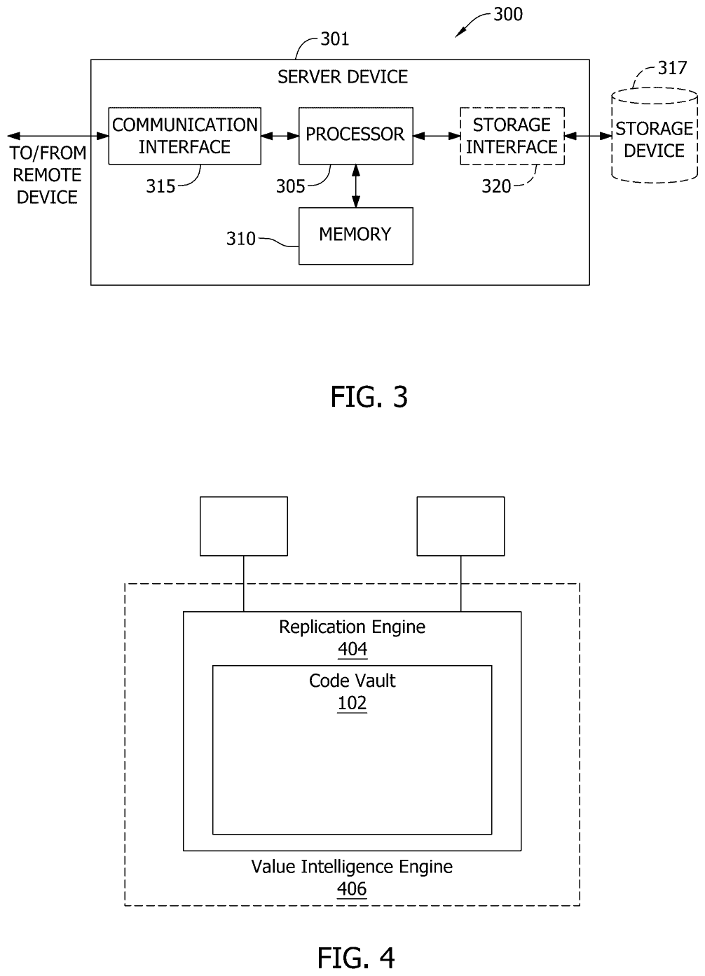

FIG. 3 depicts a block diagram 300 showing an exemplary server system 301 that may be used with CA system 100 (shown in FIG. 1). Server system 301 may be, for example, CA computing device 102 or database server 104 (shown in FIG. 1).

In exemplary embodiments, server system 301 may include a processor 305 for executing instructions. Instructions may be stored in a memory area 310. Processor 305 may include one or more processing units (e.g., in a multi-core configuration) for executing instructions. The instructions may be executed within a variety of different operating systems on server system 301, such as UNIX, LINUX, Microsoft Windows®, etc. It should also be appreciated that upon initiation of a computer-based method, various instructions may be executed during initialization. Some operations may be required in order to perform one or more processes described herein, while other operations may be more general and/or specific to a particular programming language (e.g., C, C #, C++, Java, or other suitable programming languages, etc.).

Processor 305 may be operatively coupled to a communication interface 315 such that server system 301 can communicate with CA computing device 102, client devices 108a, 108b, and 110 (all shown in FIG. 1), and/or another server system. For example, communication interface 315 may receive data from user devices 108a and 108b via the Internet.

Processor 305 may also be operatively coupled to a storage device 317, such as database 106 (shown in FIG. 1). Storage device 317 may be any computer-operated hardware suitable for storing and/or retrieving data. In some embodiments, storage device 317 may be integrated in server system 301. For example, server system 301 may include one or more hard disk drives as storage device 317. In other embodiments, storage device 317 may be external to server system 301 and may be accessed by a plurality of server systems. For example, storage device 317 may include multiple storage units such as hard disks or solid-state disks in a redundant array of inexpensive disks (RAID) configuration. Storage device 317 may include a storage area network (SAN) and/or a network attached storage (NAS) system.

In some embodiments, processor 305 may be operatively coupled to storage device 317 via a storage interface 320. Storage interface 320 may be any component capable of providing processor 305 with access to storage device 317. Storage interface 320 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 305 with access to storage device 317.

Memory area 310 may include, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only, and are thus not limiting as to the types of memory usable for storage of a computer system.

In some embodiments, the systems and methods described herein may implemented by back-end (e.g., PHP), front-end (e.g., JavaScript), scripting (e.g., BASH, and structured languages (e.g., SQL). The embodiments described are merely exemplary to provide a better understanding of the disclosed invention. The systems and methods described are in no way limited to these certain languages. Additionally, one or more software extensions may be used, including but not limited to Composer packages, jQuery Library, Node.js, Node modules, and Gulp for building and compiling tasks. Additionally, or alternatively, a plurality of third-party services and technologies may be used, including but not limited to, AWS, Setasign, Pixelcave, and hundreds of Fedora OS packages. Those of skill in the art will appreciate that the herein described apparatuses, engines, devices, systems and methods are susceptible to various modifications and alternative constructions. There is no intention to limit the scope of the invention to the specific constructions described herein. Rather, the herein described systems and methods are intended to cover all modifications, alternative constructions, and equivalents falling within the scope and spirit of the disclosure, any appended claims and any equivalents thereto.

Portions or sections of code may be replicated for convenience or performance optimization. However, excessive code replication can lead to one or more of the following issues: (i) code duplication, (ii) increased code size; (iii) reduced flexibility, and/or (iv) maintenance challenges. For example, when code is duplicated, the same logic is replicated across multiple places. Therefore, any changes or bug fixes must be applied to each instance individually. This makes the codebase more difficult to maintain and increases the likelihood of introducing inconsistencies or errors. Further, replicating code can result in larger codebases, leading to decreased readability and increased complexity. This can make the code harder to understand, debug, and maintain. In addition, if similar functionality is replicated instead of being abstracted into reusable functions or modules, it becomes harder to modify or extend that functionality in the future. Making changes in one place may require updating multiple instances, which can be time-consuming and error-prone. With code replication, it becomes challenging to ensure that all replicated instances are kept up to date and consistent. It can be harder to track down bugs or apply updates across multiple copies of the same code.

To mitigate these issues, software developers often strive for code reuse and modular design. By abstracting common functionality into reusable components, such as functions, classes, or libraries, they can reduce code replication and improve maintainability, readability, and overall software quality.

A computer code repository, also known as a code repository or source code repository, is a central location or storage system where developers can store, manage, and collaborate on computer code. It serves as a version control system that keeps track of changes made to the codebase over time and provides a platform for collaboration among multiple developers.

Code repositories are used to facilitate software development by offering one or more of the following features: (i) version control, (ii) collaboration, (iii) backup and recovery, and/or (iv) code sharing and reuse. For example, code repositories enable developers to track changes to their codebase over time. They provide mechanisms to create new versions of the code, compare differences between versions, and revert to previous versions if needed. This helps manage code history, allows collaboration between developers, and provides a way to review and manage code changes. Further, code repositories allow multiple developers to work together on the same codebase. For example, code repositories provide features like branching and merging, which enable developers to work on separate versions of the code and later integrate their changes. Collaboration tools such as issue tracking, comments, and pull requests facilitate communication and coordination among team members. In addition, by storing code in a code repository, developers have a centralized backup of their codebase. In case of accidental data loss or system failures, the code can be recovered from the repository. Repositories often have backup and redundancy measures in place to ensure the safety and availability of code. Further, code repositories provide a platform for sharing code with others. Developers can make their code public, allowing others to view, clone, and use their code in their own projects. This promotes code reuse, knowledge sharing, and collaboration within the developer community.

Commonly used code repository systems include Git (with platforms like GitHub, GitLab, and Bitbucket), Subversion (SVN), and Mercurial. These systems offer command-line tools and web-based interfaces to interact with the code repository, manage code versions, and collaborate with other developers.

FIG. 4 is a block diagram of a value intelligence engine 406. Value intelligence engine 406 may be part of CA computing system 100 and/or CA computing device 102 (shown in FIG. 1). Value intelligence engine 406 includes a code vault 402 configured to store uploaded code. In one embodiment, value intelligence engine 406 is configured to analyze code stored in code vault 402 to determine one or more metrics (e.g., a value of the code stored in the vault), as discussed in more detail below.

In one embodiment code vault 402 is configured to upload code from archives (zip/tar, etc.) and/or connect to code repositories as sources. When the code is provided, the code vault 402 is configured to create a secure “image” of the code, thereby creating a true source of their IP. Code stored in code vault 402 may be reviewed, re-uploaded with new code archives, and/or re-sync with code repositories, as discussed in more detail below. Further, code vault 402 is able to track and provide a full auditable version history of stored code, and may further have the ability to provide and restore previous versions of the code.

Once the code is vaulted, users have the ability to replicate their entire IP codebase as many times as they want. In one embodiment, the IP codebase may be replicated via replication engine 404. In one embodiment, each replication is a private, self-contained server with full root terminal access and cloud-based code editor (e.g., VSCode Server provided by Microsoft®). In one embodiment, the replication function is performed using one or more third party databases, such Clonr.

The replicated code can be editable or read only. In an embodiment in which each replication is a self-contained server, there is no risk that the original IP can be affected accidentally. If the IP has a web element to it (e.g., a web application, a website, etc.), each replication is viewable in a browser to review/test web interfaces. In one embodiment, each replication may be disposable. In such an embodiment, each replication can simply be deleted or can become the new version of the IP (once reviewed and approved by an account manager).

Replicated code can be used for one or more of the following purposes: (i) creating a new editable version of the IP that developers could be invited to work on, which can then become a new IP version after review, (ii) creating a read-only version of the IP that potential investors or security analysts can review, before the replication is deleted; and/or (iii) spinning off a version of the IP that can be changed to become a new product, without affecting the original IP. A full history of all replication actions and changes may be tracked and maintained by code vault 402.

In one embodiment, different users are provided different accesses. For example, a chief technology officer (CTO) may have unlimited access to code within code vault 402, whereas a third-party investor may only have access to a read-only version of the code.

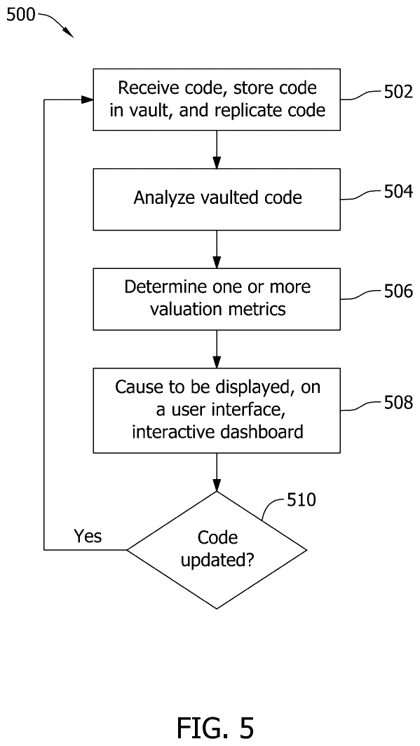

FIG. 5 is a flow chart 500 of a valuation process, in accordance with an embodiment. Method may be performed by one or more processors. In one embodiment, method is performed by one or more components of CA system 100 and/or CA computing device 102 (shown in FIG. 1). At 502, a codebase and/or code is received, stored in a code vault, and replicated. Having a private code repository separate from your development partner or development environments can be important for several reasons. For example, it may be important with regards to intellectual property concerns, security, and maintaining control over the software development process. For example, by storing code in a separate and secure location, the impact of data breaches, ransomware attacks, and other security incidents can be mitigated. In one embodiment, authentications rules are applied to verify a user or other data.

Next, at 504, the vaulted code is analyzed. For example, in one embodiment, a replication value of the vaulted code is determined. In one embodiment, the analysis utilized one or more algorithms and/or AI and/or ML techniques. In one embodiment, the analysis includes determining a value representing the amount of code (e.g., the number of lines of code). Although more lines of code does not necessarily equal the value of the code, the amount of written code does impact the cost it takes to replicate. In a further embodiment, open-source code (e.g., code that is made freely available for possible modification and redistribution) is identified and not included in the value representing the amount of code. Additionally, or alternatively, the analysis includes determining the number and/or types of programming languages used (e.g., C, C #, C++, Java, SQL, etc.). Certain programming languages are more expensive and harder to replicate and therefore the number and type of programming languages impact cost, complexity, etc. of code. Additionally, or alternatively, the code analysis may include the number and/or types of files used; if any third party packages are used, and if so, what type of third party packages are used, if they are outdated, etc.; any known security vulnerabilities within the code from vulnerability databases; any detected malware within the code; if the source of code was a GIT repository; how many contributors have worked on the code and stats associated with each contributor, such as number of changes, most recent changes, etc.; the coding standards; and/or the quality of code.

At 506, one or more valuation metrics are determined. In one embodiment, the one or more valuation metrics are based the code analysis performed in 506. For example, one or more valuation metrics are determined based on the amount of code (e.g., lines of code), the number and/or types of programming languages used, etc. The one or more valuation metrics may include a “cost to replicate value”. The cost to replicate value may include costs associated with replicating the vaulted code. However, the one or more valuation metrics may be one or more of (i) a cost-based metric, (ii) a market-based metric, (iii) an income-based metric, and/or (iv) a royalty-based metric. The cost-based metric focuses on the on the cost required to develop or maintain the code. It involves evaluating the resources, time, and effort invested in creating the code. Factors such as development hours, personnel costs, software and hardware expenses, and ongoing maintenance costs are considered. Therefore, the cost-based metric provides a rough estimate of the value based on the expenses incurred. The market-based metric is determined by assessing the market demand and pricing for similar code or software products. Comparable sales, licensing fees, or benchmarking against similar products in the market can be used to estimate the value. Therefore, the market-based metric relies on market research and analysis to determine the value based on supply and demand dynamics. The income-based metric focuses on estimating the potential income or financial benefits that can be generated by the code. It involves evaluating factors such as projected revenue, cost savings, increased efficiency, and potential market share. This income-based metric is often used for evaluating commercial software products or codebases with revenue-generating potential. The royalty-based metric may be used for code that is intended for licensing or royalty-based revenue models. The value is determined by estimating the potential royalty payments or licensing fees that can be generated from the code over a specific period. Factors such as market size, expected usage, and licensing terms are considered in the royalty-based metric. Additional data necessary for determining the one or more metric (e.g., employee wages, royalties, etc.) may be retrieved from database 106 and/or another source using AI, as discussed in more detail below.

At 508, an interactive dashboard is displayed on a user interface. Interactive dashboard can have charts and widgets for data from the analysis performed at 504 and the one or more valuation metrics determined at 506, including, but not limited to: (i) how many lines of code the IP contains; (ii) the number and/or type of files; (iii) the number and/or type of programming languages used; (iv) if third party packages are used, and if so, what the third-party packages are used and if they are outdated; (v) any known security vulnerabilities within the code from vulnerability databases; (vi) any detected malware within the code; (vii) if the source of code was a GIT repository, how many contributors have worked on the IP and what are their stats (e.g., how many changes, most recent changes), which may depend on a supported GIT platform (e.g., github, gitlab, etc.); and/or (viii) an analysis of coding standards and quality of code.

At 510, if a code update notice is received, the process returns to 502. Software is constantly changing, so it is important to not only create an initial secure replication of code, but to keep the code updated regularly. In one embodiment, the code stored in the vault is updated according to a predetermine schedule (e.g., every week, every month, etc.). The predetermined schedule may be selected by a user. Additionally, or alternatively, the code stored in the vault can be updated manually by a user. Each time the code is updated, the process returns to 502, and the code is stored, replicated, and re-analyzed. In one embodiment, when the code is updated, the code is automatically stored and re-analyzed, and the interactive dashboard is automatically updated and/or a new report is automatically generated. In a further embodiment, the new report is automatically sent to one or more users via email, text message, or the like. In one embodiment, each time the code is updated, a report is automatically create summarizing the changes that have been made to the code. In a further embodiment, the report summarizing the changes is automatically send to one or more users via email, text message, or the like.

In one embodiment, the determination of the one or more valuation metrics leverages one or more algorithms and/or AI/ML techniques. For example, in one embodiment, the algorithm employs one or more algorithms to estimate the cost to replicate the source code using the amount of source code, employee wages data, etc.

Further, in one embodiment one or more algorithms and/or AI/ML, using various factors including the codebase and details of the business model, an IP a monetary valuation and may estimate how many man hours and time/cost it would take to replicate the user's IP, based on various factors.

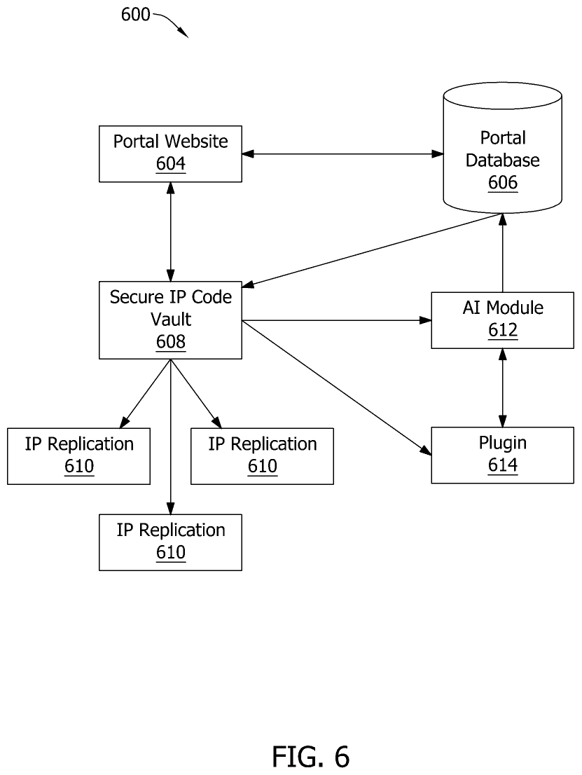

FIG. 6 is a block diagram of a CA architecture 600 in accordance with an embodiment. CA architecture 600 may be part of CA computing system 100 and/or CA computing device 102 (shown in FIG. 1).

CA architecture 600 includes a portal website module 604 configured to maintain a website and/or application (“app”) which enables a user to view and interact with CA data. In one embodiment, the portal website module 604 may be built with Laravel as the backend, and VueJS as the responsive frontend. Additionally, or alternatively portal website module 604 may be hosted on Azure® App Service. Portal website module 604 is communicatively coupled to a portal database 606. In one embodiment, portal database 606 may use Azure® MySQL server, and files are stored on Azure® Blob Storage. In one embodiment, each code vault is a container image. In a further embodiment, each code vault is stored using “encryption at rest” for maximum security of any IP code. In one embodiment, IP code replication may use Container App service provided by Azure®, with “scale-to-zero” configured by default.

CA architecture 600 further incudes an IP code vault 608 for storing one or more IP replications 610 (e.g., replicas of code). IP code vault 608 may be communicatively coupled to portal website 604 and/or portal database 606. There may be various Python functions developed using Azure® Functions, which is triggered by various events. For example once an IP code vault is created, an analysis function is triggered that will analyze the code for primary languages, total lines of code and more, as discussed above.

CA architecture 600 further includes AI module 612. AI module 612 may be communicatively coupled to portal database 606 and/or secure IP code vault 608. More particularly, AI module 612 may be configured to receive data stored in IP code vault 608 (e.g., IP replication 610) and analyze such data. In one embodiment, AI module 612 includes one or more AI voice bots, chatbots, or the like. The voice bots or chatbots discussed herein may be configured to utilize ML and/or AI techniques. For instance, the voice bot or chatbot may be an AI chatbot. The voice bot or chatbot may employ supervised or unsupervised machine learning techniques, which may be followed by, and/or used in conjunction with, reinforced or reinforcement learning techniques. The AI voice bot and/or chatbot may include a name and/or an avatar. A user may use the AI voice bot and/or chatbot to ask questions and request certain tasks be performed, including, but not limited to: (i) which employee(s) have contributed the most code to the code vault? (ii) what are the 3 primary languages or technologies used in my code? (iii) write a brief for a new development team explaining how the IP works so they can develop it further, (iv) what packages or languages are out of date? (v) what are the most important out of date packages which we should get fixed as soon as possible? and/or (vi) who can I talk to about selling my product?

In one embodiment, CA architecture 600 further includes a third-party plugin 614. Plugin 614 may be configured to assist AI module 612 in consuming and analyzing data regarding the data stored in IP code vault 608 and answer user questions. In one embodiment, plugin 614 is an OpenAI API with the GPT4 model. However, third-party plugin 614 may include any third-party API that may be used to assist AI module 612. Plugin 614 may be communicatively coupled to IP code vault 608 and/or AI module 612.

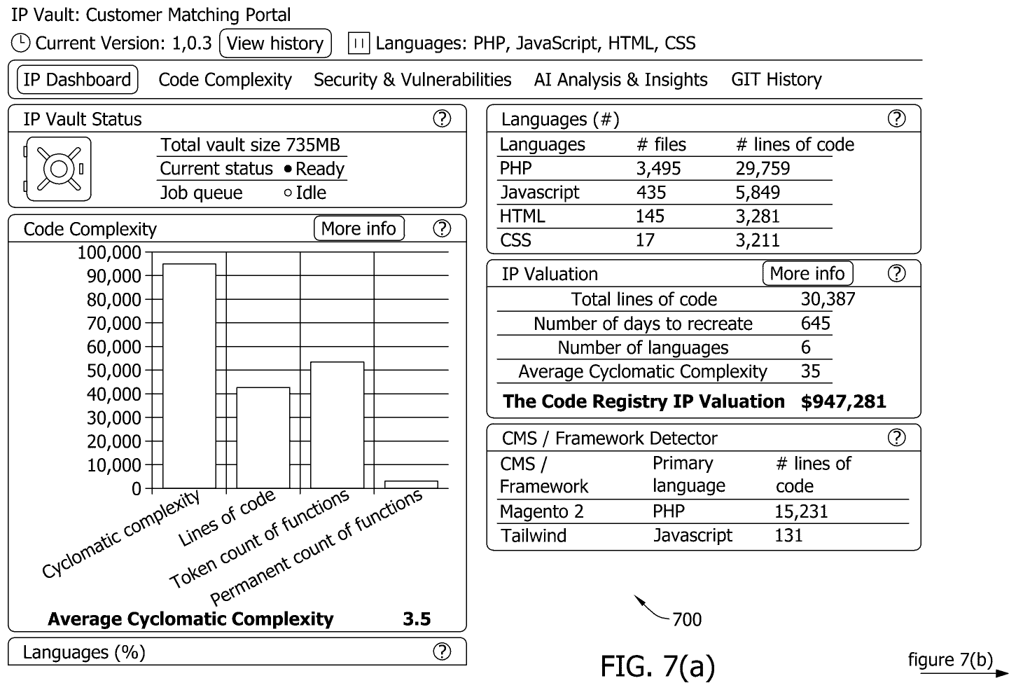

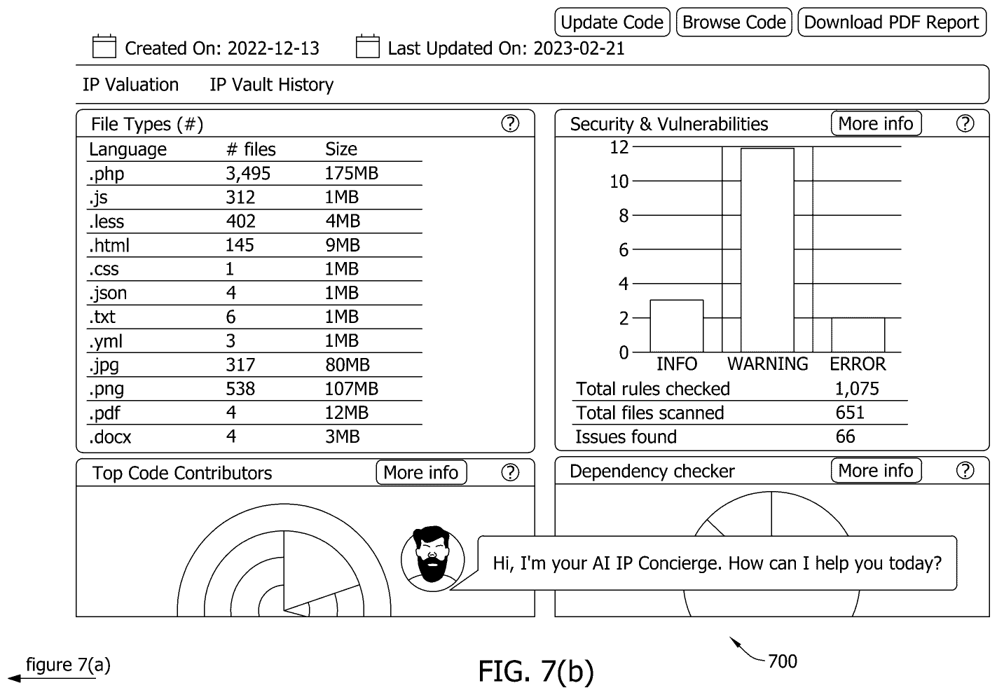

As illustrated in FIGS. 7-14, once the IP code analyses have been performed, the user may access an interactive dashboard that can have charts and widgets for data including, but not limited to: (i) how many lines of code the IP contains; (ii) the number and/or type of files; (iii) the number and/or type of programming languages used; (iv) if third party packages are used, and if so, what the third-party packages are used and if they are outdated; (v) any known security vulnerabilities within the code from vulnerability databases; (vi) any detected malware within the code; (vii) f the source of code was a GIT repository, how many contributors have worked on the IP and what are their stats (e.g., how many changes, most recent changes), which may depend on a supported GIT platform (e.g., github, gitlab, etc.); and/or (viii) an analysis of coding standards and quality of code.

More particularly, FIG. 7 is a first user interface 700 in accordance with an embodiment of the present disclosure. First user interface 700 may display an IP dashboard which provides an overview of a particular code vault. For example, first user interface 700 may display IP vault status, code complexity, type and number of each programming language used, IP valuation, CMS/Framework detector, file types and number of each file type, top code contributors, GIT analysis, security and vulnerabilities, and dependency checker. However, the foregoing list is mean to be illustrative and not exhaustive.

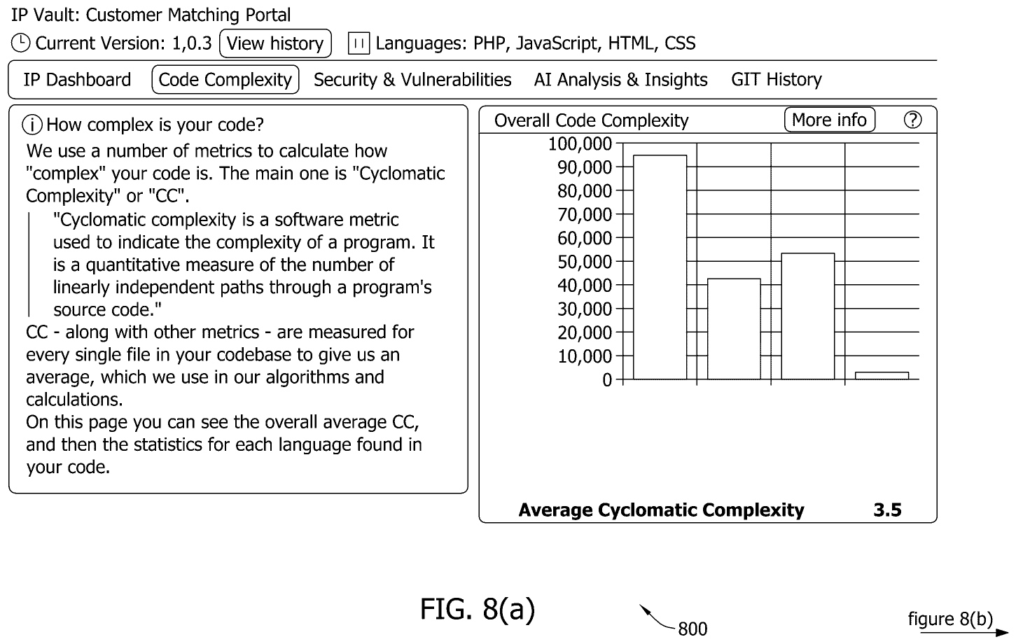

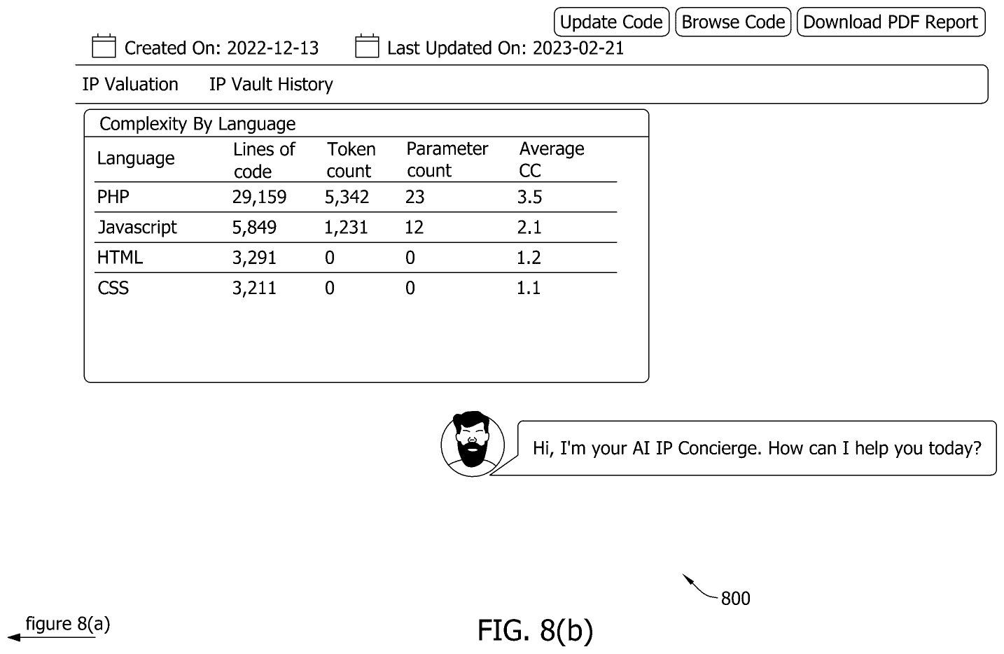

FIG. 8 is a second user interface 800 in accordance with an embodiment of the present disclosure. Second user interface 800 may display an overview of the code complexity as determined by the analysis of the source code. For example, second user interface may display information regarding cyclomatic complexity, the number of lines of code, the token count of functions, and/or a parameter count for functions of the source code, the type of languages used and the amount (e.g., number of files, number of lines of code, etc.) of each language used, and the like. However, the foregoing list is mean to be illustrative and not exhaustive. In one embodiment, second user interface 800 further includes a summary of information, such as how complex the source code is, what certain terms mean, and the like. In one embodiment, the summary is generated using AI.

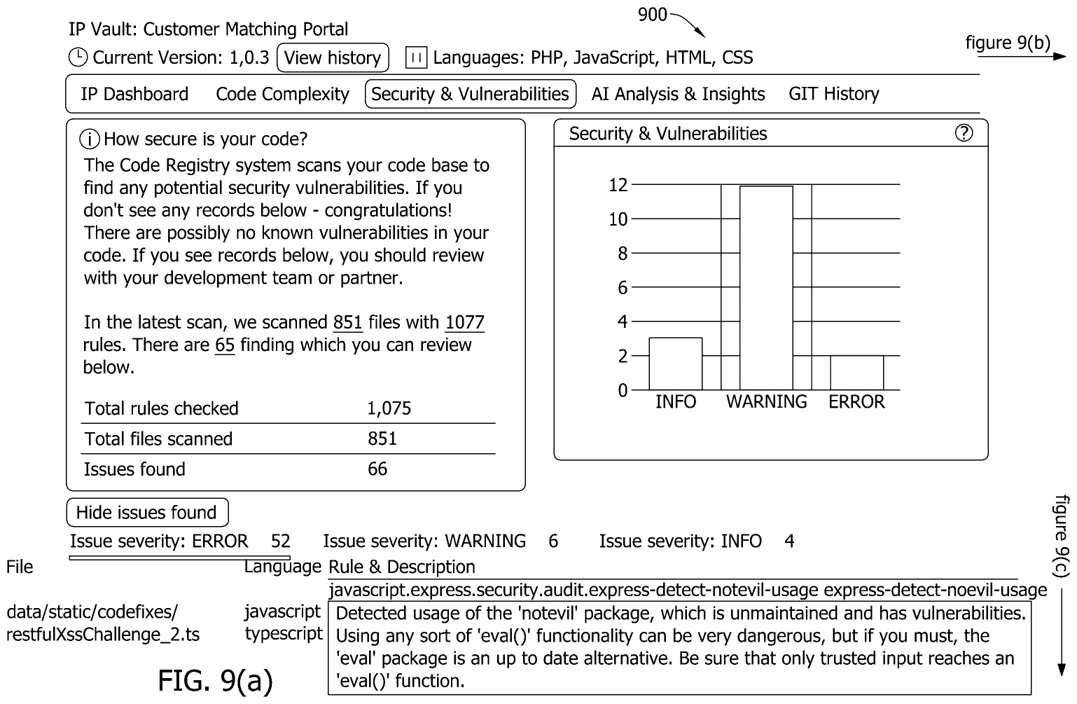

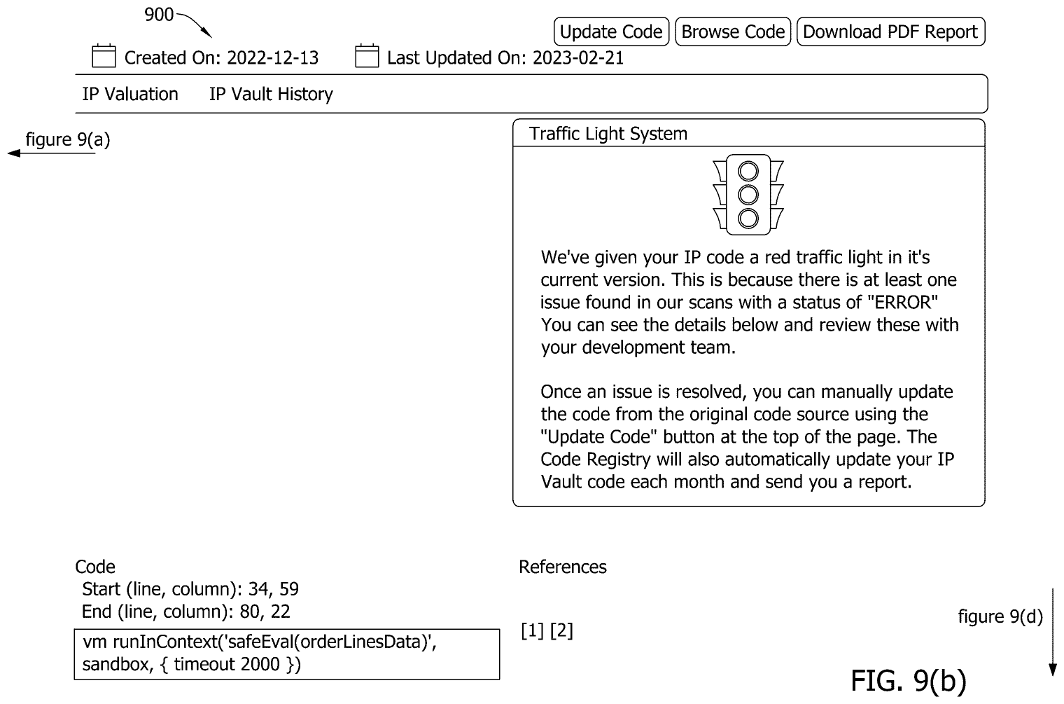

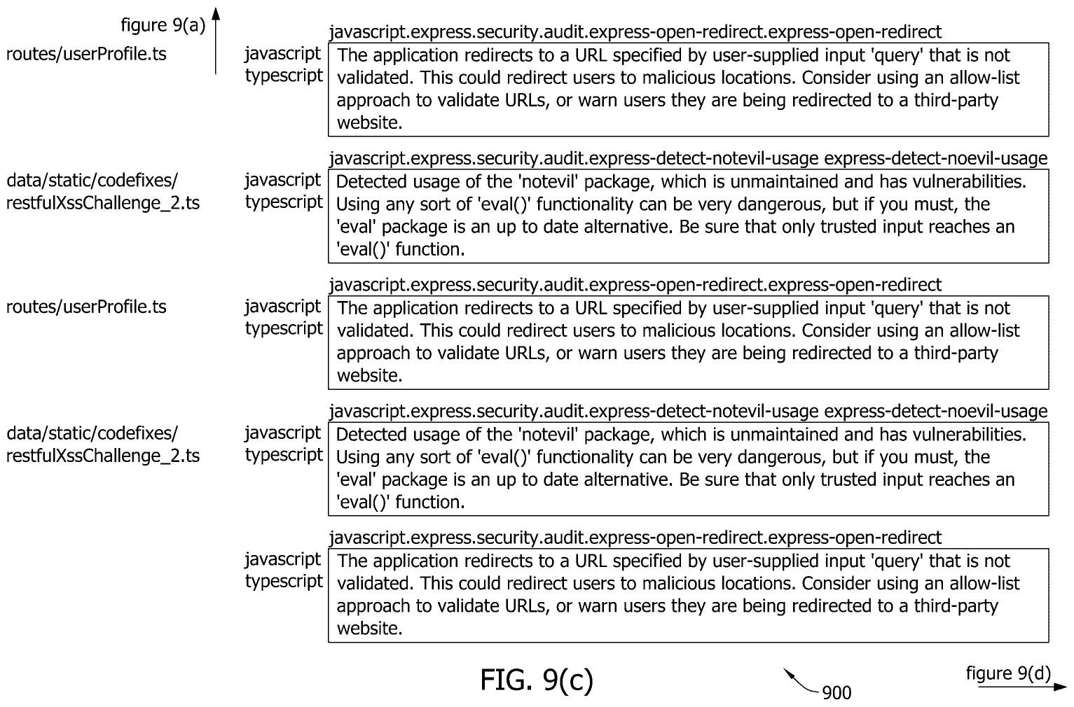

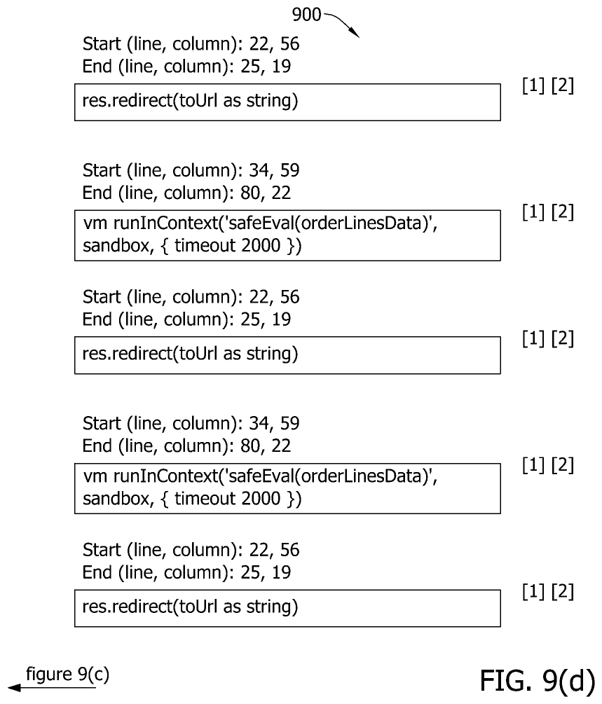

FIG. 9 is a third user interface 900 in accordance with an embodiment of the present disclosure. Third user interface 900 may display an overview of the code security and vulnerabilities as determined by the analysis of the source code. For example, third user interface 900 may display information regarding information, warnings, and errors contained in the code and a score based on at least one of the information, warning, and/or error information. However, the foregoing list is mean to be illustrative and not exhaustive. The security score and/or indication representing the security score may be displayed on third user interface 900. For example, in the embodiment illustrated in FIG. 9, a “traffic light” is provided on third user interface 900 and the source code has a “red light” (e.g., corresponding to one or more issues being found in the source code), a “yellow light” (e.g., corresponding to one or more warnings found in the source code, but no issues found), and a “green light” (e.g., corresponding to no warnings or issues being found in the source code). In one embodiment, third user interface 900 further includes a summary of information, how secure the code is, the number of rules checked, the total files scanned, the number of issues found, and the like. In one embodiment, the summary is generated using AI. In one embodiment, third user interface 900 further includes a list of instances of the issues, warnings, and/or information found during the scan (e.g., may list the specific errors found in the code). The list of instances may include which file(s) the error, warning, and/or information is located in the source code and a rule and description of the error, warning, or information. In one embodiment, the rule and/or description is generated using AI.

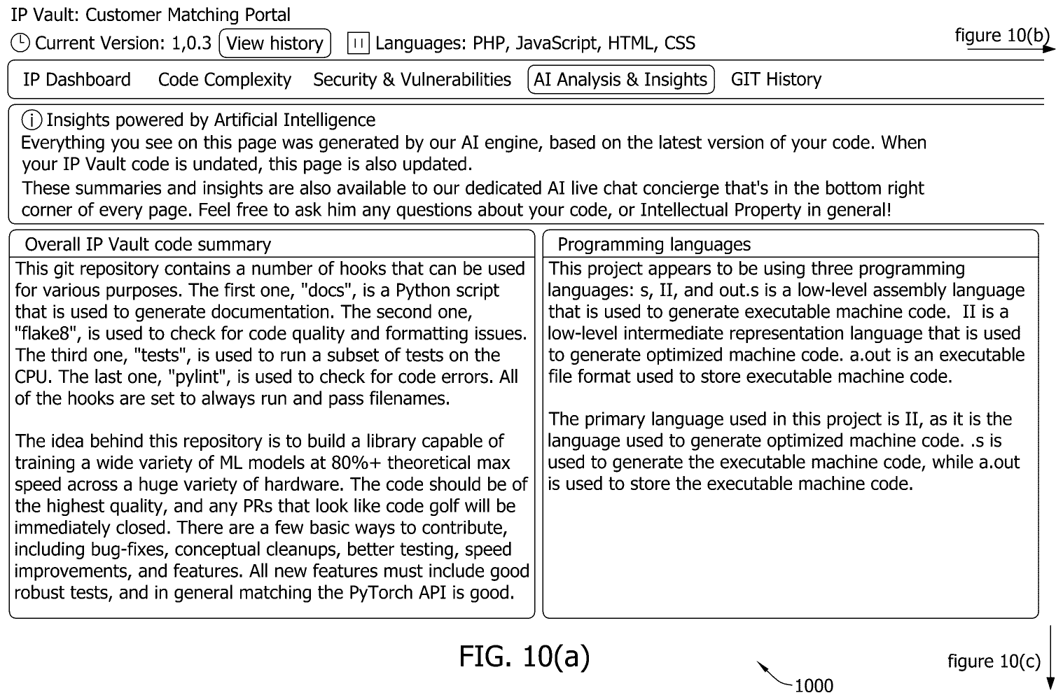

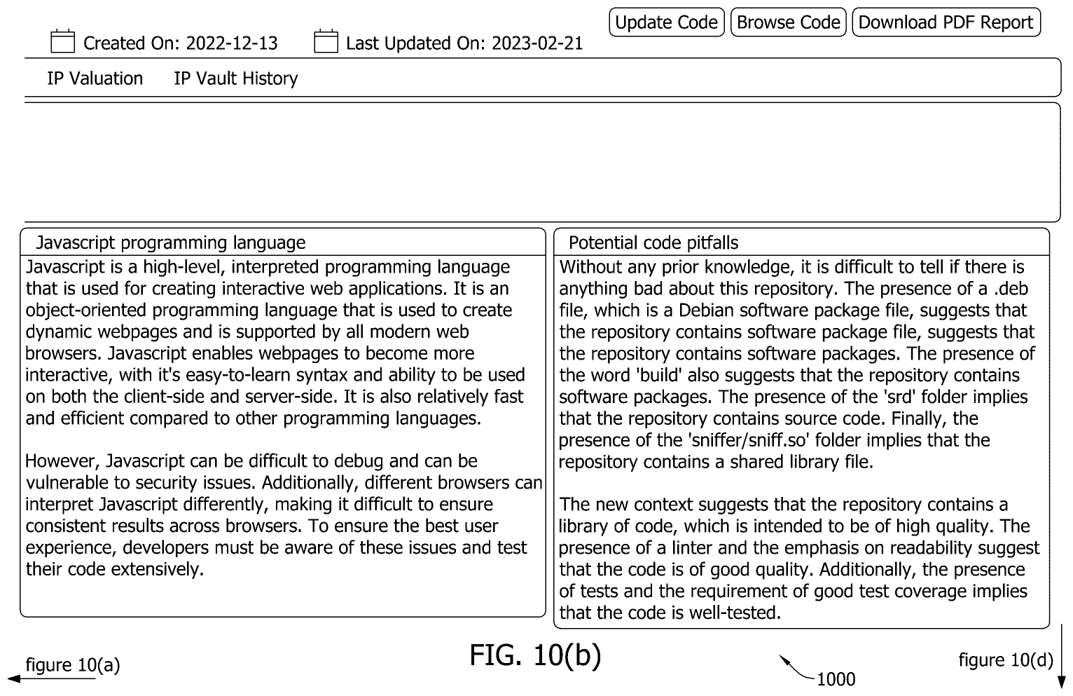

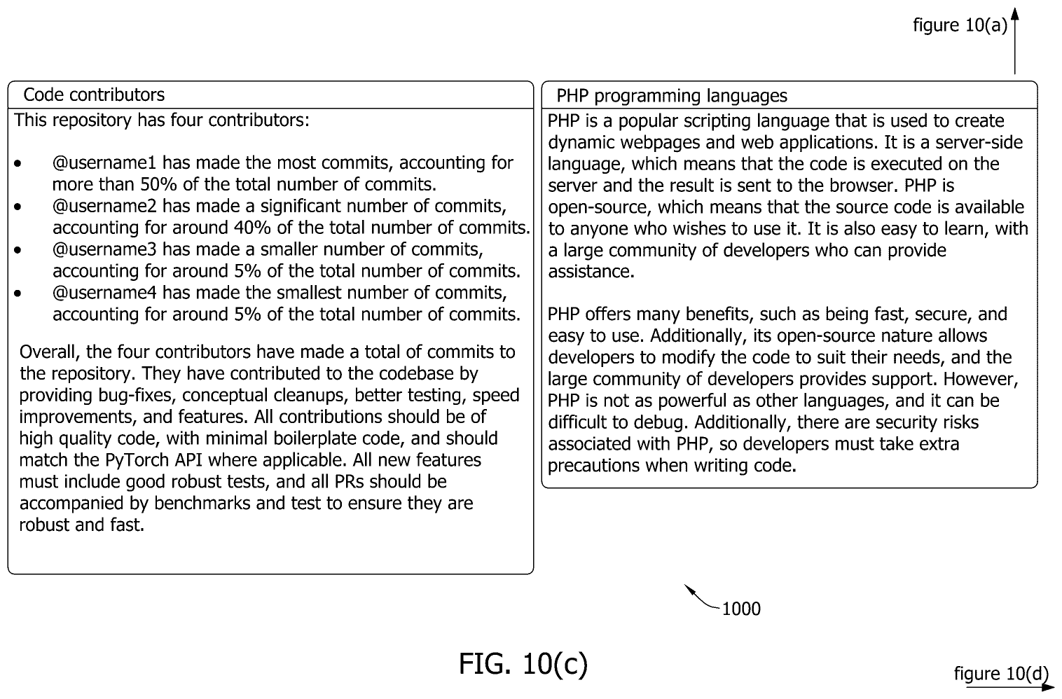

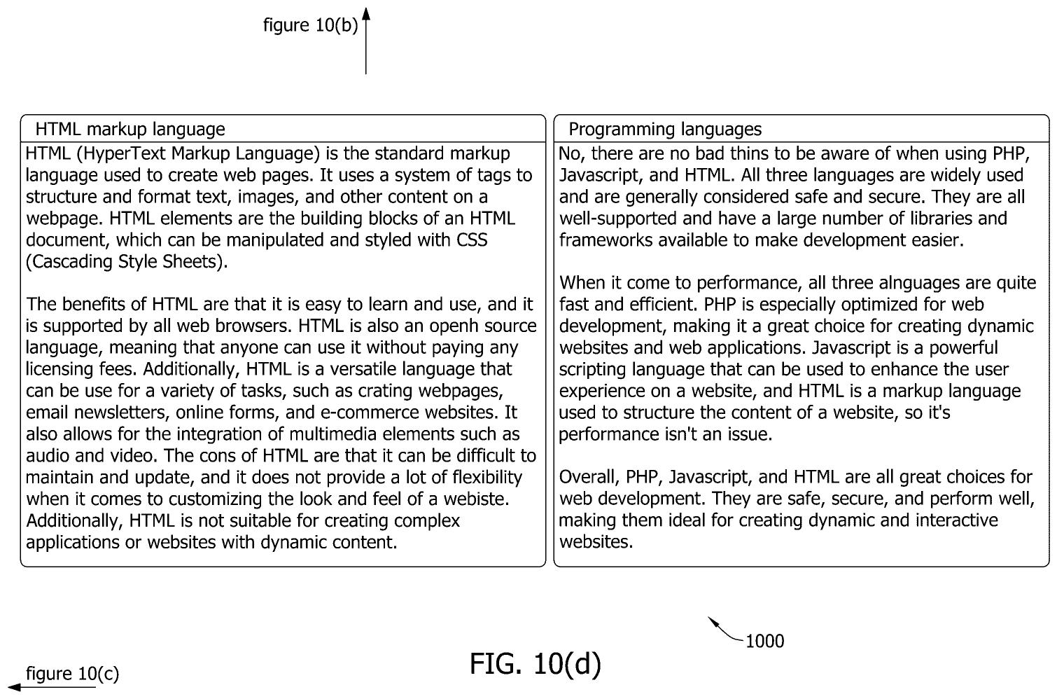

FIG. 10 is a fourth user interface 1000 in accordance with an embodiment of the present disclosure. Fourth user interface 1000 may display AI insights and analytics. For example, fourth user interface 1000 may display an overall summary of the source code, a summary of the code contributors, a summary of the programming languages used, a summary of potential code pitfalls, summaries of the programming languages themselves, and the like. However, the foregoing list is mean to be illustrative and not exhaustive. The AI insights and analytics information is generated using AI.

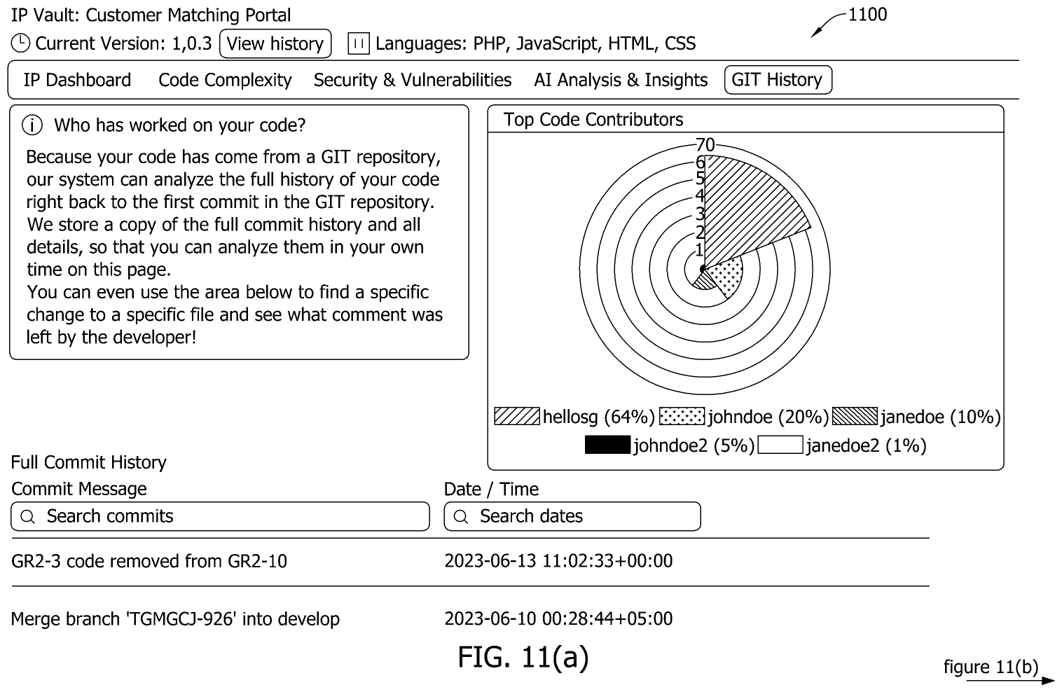

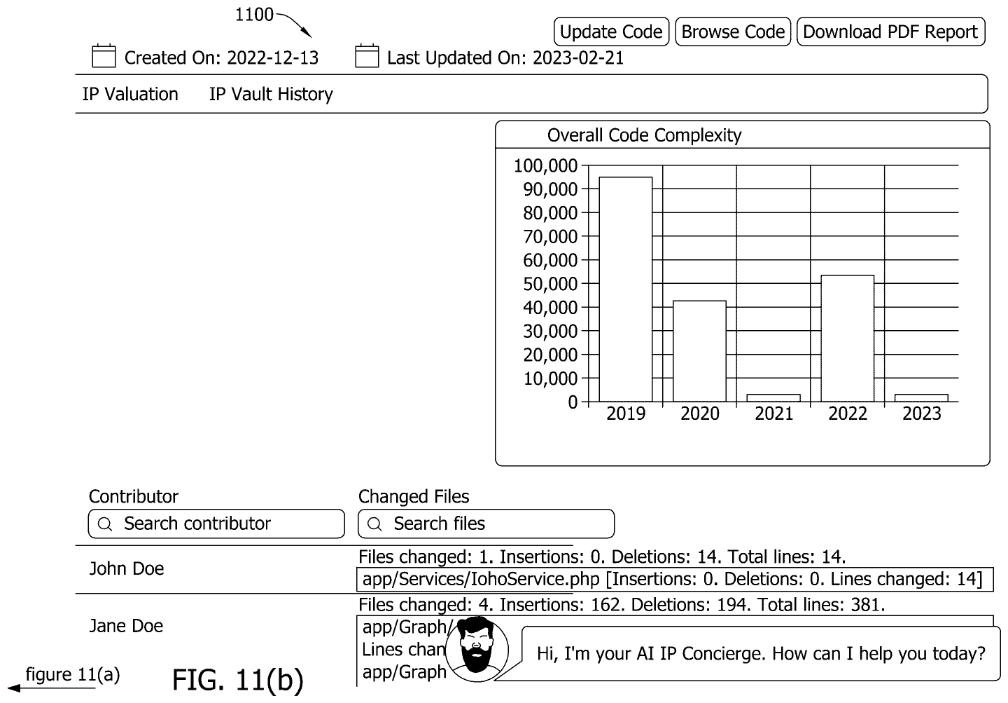

FIG. 11 is a fifth user interface 1100 in accordance with an embodiment of the present disclosure. Fifth user interface 1100 may display code history. For example, fifth user interface may include a graph of top code contributors and indications of how much they contributed, the number of commits per year, month, etc., and the like. However, the foregoing list is mean to be illustrative and not exhaustive. In one embodiment, fifth user interface 1100 includes a summary of the code history. In one embodiment, the summary is generated using AI. In one embodiment, fifth user interface 1100 further includes a list of specific changes to the code and information regarding each change (e.g., the date/time the change was made, who made the change, what the change was, and the like).

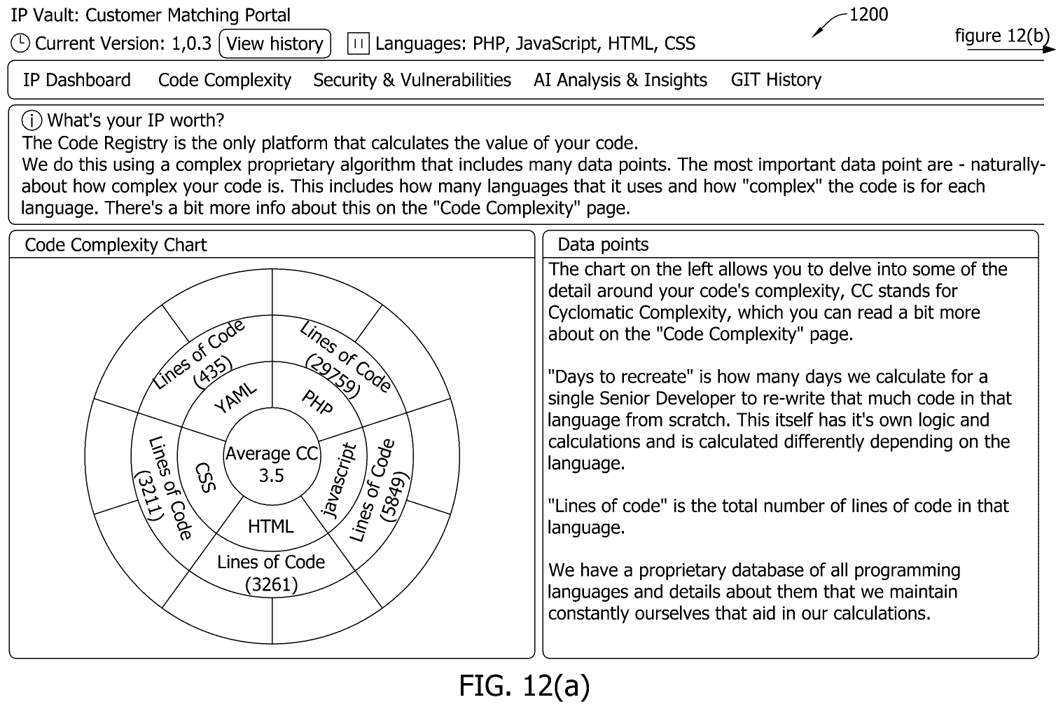

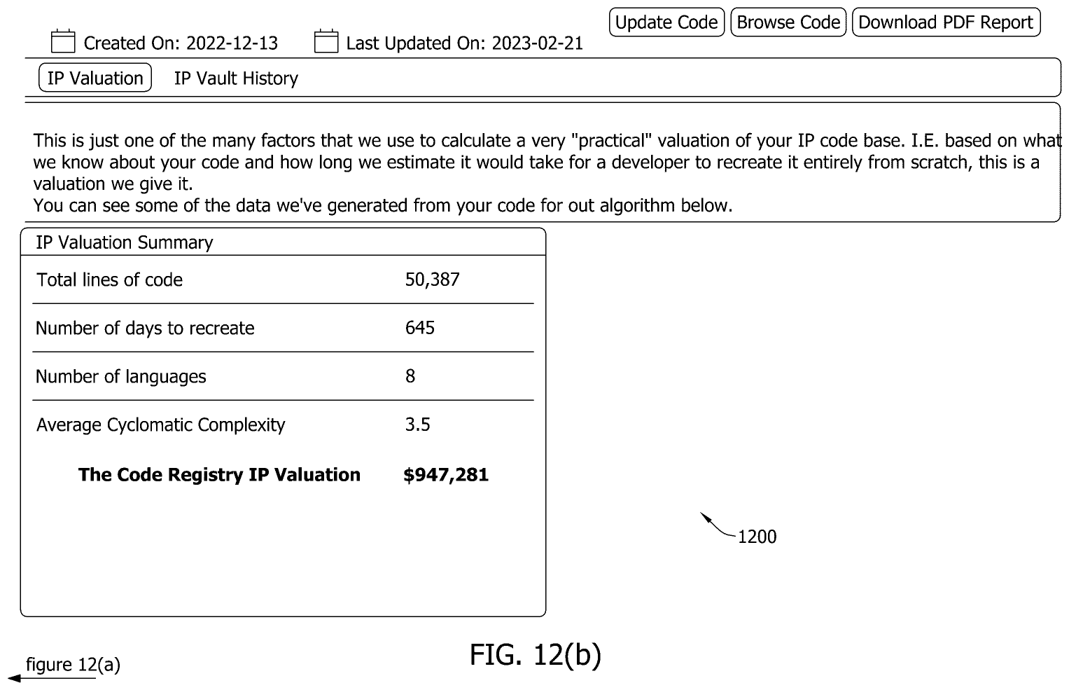

FIG. 12 is a sixth user interface 1200 in accordance with an embodiment of the present disclosure. Sixth user interface 1200 may display IP valuation data. For example, sixth user interface 1200 may include code complexity information, such as a chart, data points regarding the code complexity, and an IP valuation summary (e.g., total lines of code, estimated number of days it would take to recreate, the number of languages used, the average cyclomatic complexity, and the like). The IP valuation summery may further include an estimated IP valuation. In one embodiment, some or all of the IP valuation data is generated using AI. In one embodiment, sixth user interface 1200 further includes a summary of the IP valuation and information regarding how the IP valuation data was calculated, the factors that went into calculating the IP valuation, and the like. In one embodiment, the summary is generated using AI.

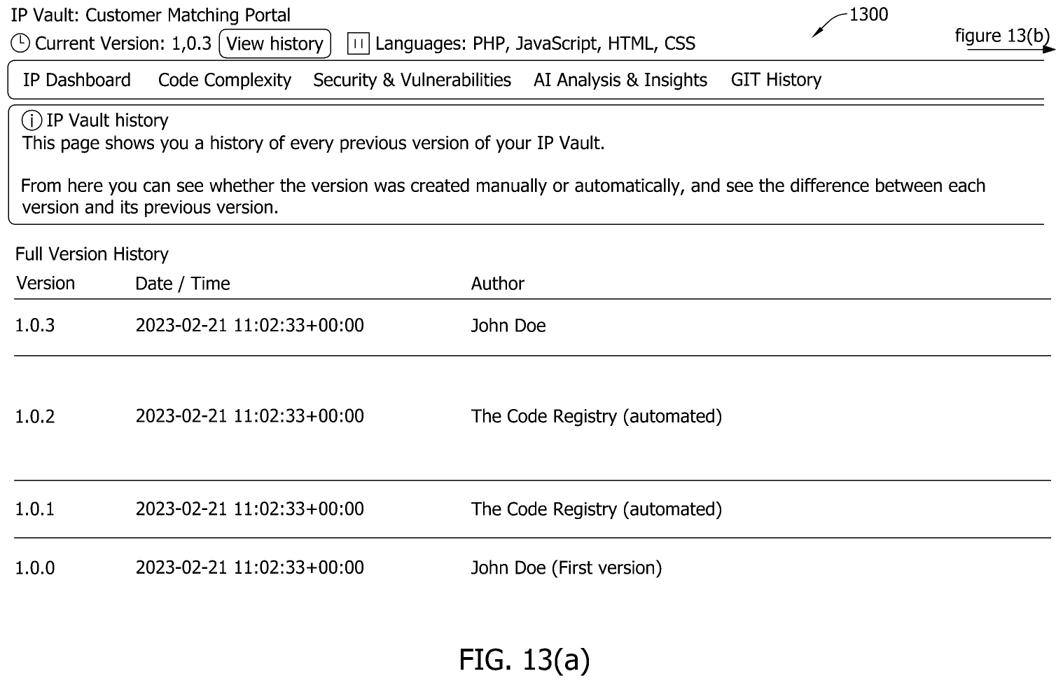

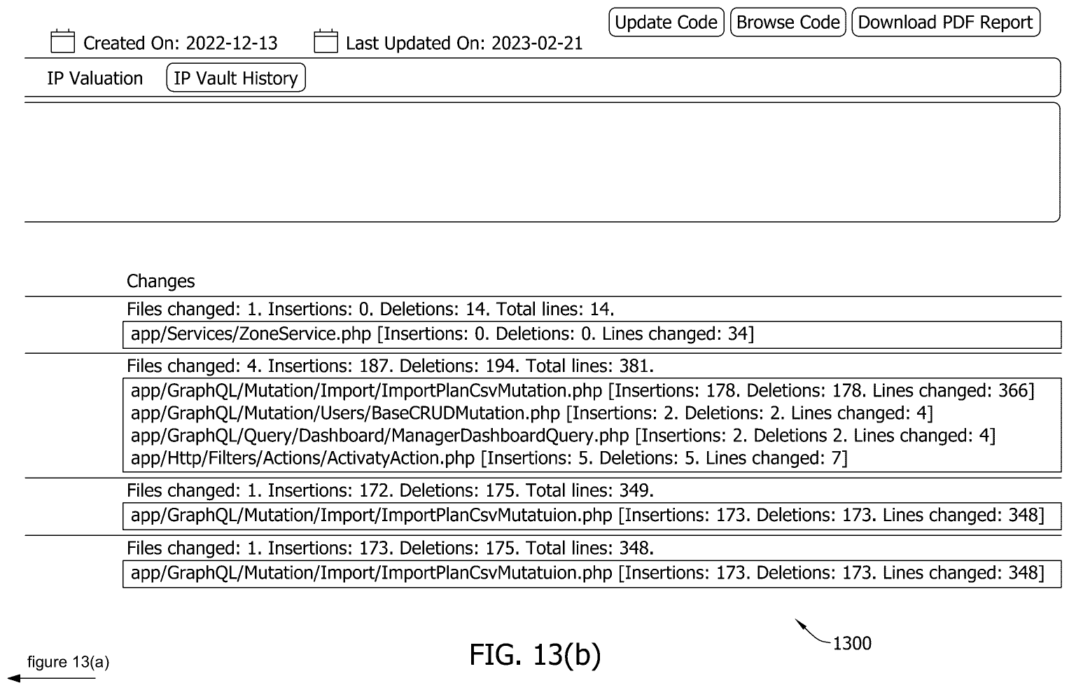

FIG. 13 is a seventh user interface 1300 in accordance with an embodiment of the present disclosure. Seventh user interface 1300 may display information regarding the history of the code vault. For example, seventh user interface 1300 may include information regarding the versions of the code, the date/time each version was updated, authors associated with the version, the changes associated with the version (e.g., files changed, insertions, deletions, etc.), and the like. However, the foregoing list is meant to be illustrative and not exhaustive. Seventh user interface 1300 may further include a summary of the code vault history, including information regarding the code vault history. In one embodiment, the summary is generated using AI.

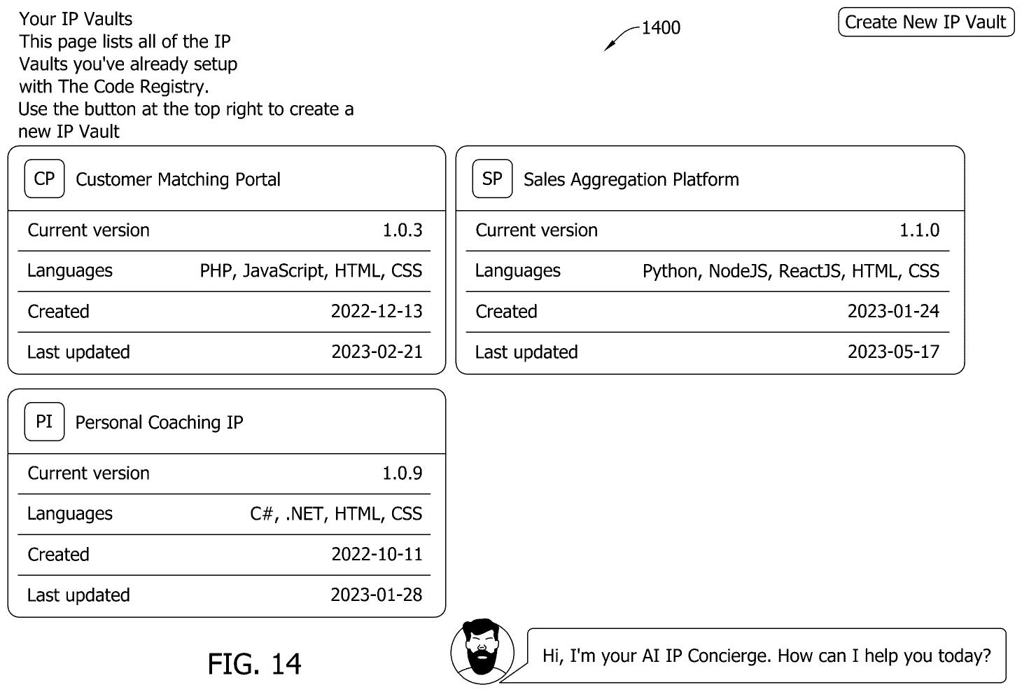

FIG. 14 is an eighth user interface 1400 in accordance with an embodiment of the present disclosure. Eighth user interface 1400 may display information regarding the code vaults associated with a user. In this way, a user may view all of the code vaults they have access to and basic information regarding each code vault, including, but not limited to the name of the code vault, the languages used, the date and time created, and/or the date and time of the last update.

The preceding information is also accessible by querying the AI voice bot and/or chatbot. The AI voice bot and/or chatbot may include a name and/or an avatar. In one embodiment, the AI voice bot and/or chatbot utilizes the OpenAI set of APIs and the latest GPT4 model and plugin functionality. Using the AI voice bot and/or chatbot, users may be able to ask questions/tasks including, but not limited to: (i) which employee(s) have contributed the most code to the code vault? (ii) what are the 3 primary languages or technologies used in my code? (iii) write a brief for a new development team explaining how the IP works so they can develop it further, (iv) what packages or languages are out of date? (v) what are the most important out of date packages which we should get fixed as soon as possible? and/or (vi) who can I talk to about selling my product? Each of FIGS. 7-14 may provide access to the AI voice bot and/or chatbot.

In one embodiment, an analysis dashboard may be downloadable as a presentation, such as a PDF, containing all of the relevant data. In one embodiment, the presentation may customizable. For example, in one embodiment, a user interface may enable a user to select, modify, delete, or otherwise edit, the data the user would like to be presented in the report.

The computer-implemented methods discussed herein may include additional, less, or alternate actions, including those discussed elsewhere herein. The methods may be implemented via one or more local or remote processors, transceivers, servers, and/or sensors, and/or via computer-executable instructions stored on non-transitory computer-readable media or medium.

Additionally, the computer systems discussed herein may include additional, less, or alternate functionality, including that discussed elsewhere herein. The computer systems discussed herein may include or be implemented via computer-executable instructions stored on non-transitory computer-readable media or medium.

A processor or a processing element may employ artificial intelligence and/or be trained using supervised or unsupervised machine learning, and the machine learning program may employ a neural network, which may be a convolutional neural network, a deep learning neural network, or a combined learning module or program that learns in two or more fields or areas of interest. Machine learning may involve identifying and recognizing patterns in existing data in order to facilitate making predictions for subsequent data. Models may be created based upon example inputs in order to make valid and reliable predictions for novel inputs.

Additionally or alternatively, the machine learning programs may be trained by inputting sample data sets or certain data into the programs, such as image data, text data, and/or numerical analysis. The machine learning programs may utilize deep learning algorithms that may be primarily focused on pattern recognition, and may be trained after processing multiple examples. The machine learning programs may include Bayesian program learning (BPL), voice recognition and synthesis, image or object recognition, optical character recognition, and/or natural language processing-either individually or in combination. The machine learning programs may also include natural language processing, semantic analysis, automatic reasoning, and/or machine learning.

In supervised machine learning, a processing element may be provided with example inputs and their associated outputs, and may seek to discover a general rule that maps inputs to outputs, so that when subsequent novel inputs are provided the processing element may, based upon the discovered rule, accurately predict the correct output. In unsupervised machine learning, the processing element may be required to find its own structure in unlabeled example inputs. In one embodiment, machine learning techniques may be used to extract data about the computer device, the user of the computer device, driver and/or vehicle, documents to be provided, the model being simulated, homeowner and/or home, buyer, geolocation information, image data, home sensor data, and/or other data.

Based upon these analyses, the processing element may learn how to identify characteristics and patterns that may then be applied to training models, analyzing sensor data, authentication data, image data, mobile device data, and/or other data.

In the foregoing detailed description, it may be that various features are grouped together in individual embodiments for the purpose of brevity in the disclosure. This method of disclosure is not to be interpreted as reflecting an intention that any subsequently claimed embodiments require more features than are expressly recited.

Further, the descriptions of the disclosure are provided to enable any person skilled in the art to make or use the disclosed embodiments. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but rather is to be accorded the widest scope consistent with the principles and novel features disclosed herein.

What is claimed is:

1. A system for evaluating security and vulnerabilities of source code, the system comprising:
at least one memory storing computer-executable instructions; and
at least one processor in communication with the at least one memory, wherein the at least one processor is configured to execute the computer-executable instructions to:
receive, from a database, source code;
scan the source code and determine if the source code contains at least one of one or more issues or one or more warnings;
determine, based on the scan, a security score for the source code; and
cause to be displayed, on a user interface, an interactive dashboard displaying an indication representing the security score for the source code and an explanation of the security score.

2. The system of claim 1, wherein the at least one processor is further configured to execute the computer-executable instructions to cause to be displayed, on the user interface, at least one of a total number of files scanned, a total number of rules checked, a total number of issues found, or a total number of warnings found.

3. The system of claim 1, wherein the at least one processor is further configured to execute the computer-executable instructions to cause to be displayed, on the user interface, a file containing a specific instance of an error or warning and a description of the specific instance of the error or the warning.

4. The system of claim 3, wherein the at least one processor is further configured to execute the computer-executable instructions to cause to be displayed, on the user interface, one or more lines of code containing the specific instance of the error or the warning.

5. The system of claim 1, wherein the at least one processor is further configured to execute the computer-executable instructions to scan the source code and determine if the source code contains one or more issues warranting an informational notice.

6. The system of claim 5, wherein the at least one processor is further configured to execute the computer-executable instructions to, cause to be displayed, on the user interface, a name of a file containing a specific instance of an informational warning and a description of the specific instance of the informational warning.

7. The system of claim 1, wherein the at least one processor is further configured to execute the computer-executable instructions to provide an AI voice bot or chatbot configured to employ AI to answer questions and perform tasks regarding security of the source code.

8. A computer-based method for evaluating security and vulnerabilities security of source code, the computer-based method implemented using a system including a computing device including at least one processor communicatively coupled to a memory device, the computer-based method comprising:
receiving, from a database, source code;
scanning the source code and determining if the source code contains at least one of one or more issues or one or more warnings;
determining, based on the scan, a security score for the source code; and
causing to be displayed, on a user interface, an interactive dashboard displaying an indication representing the security score for the source code and an explanation of the security score.

9. The computer-based method of claim 8, further comprising causing to be displayed, on the user interface, at least one of a total number of files scanned, a total number of rules checked, a total number of issues found, or a total number of warnings found.

10. The computer-based method of claim 8, further comprising causing to be displayed, on the user interface a name of a file containing a specific instance of an error or warning and a description of the specific instance of the error or the warning.

11. The computer-based method of claim 10, further comprising causing to be displayed, on the user interface, one or more lines of code containing the specific instance of the error or the warning.

12. The computer-based method of claim 8, further comprising scanning the source code and determine if the source code contains one or more informational warnings.

13. The computer-based method of claim 12, further comprising causing to be displayed, on the user interface, a file containing a specific instance of an informational warning and a description of the specific instance of the informational warning.

14. The computer-based method of claim 8, wherein the at least one processor is further configured to execute the computer-executable instructions to provide an AI voice bot or chatbot configured to employ AI to answer questions and perform tasks regarding security of the source code.

15. At least one non-transitory computer-readable storage medium having computer-executable instructions embodied thereon, wherein when executed by at least one processor, the computer-executable instructions cause the at least one processor to:
receive, from a database, source code;
scan the source code and determine if the source code contains at least one of one or more issues or one or more warnings;
determine, based on the scan, a security score for the source code; and
cause to be displayed, on a user interface, an interactive dashboard displaying an indication representing the security score for the source code and an explanation of the security score.

16. The at least one non-transitory computer-readable storage medium of claim 15, wherein the computer-executable instructions further cause the at least one processor to, cause to be displayed, on the user interface, at least one of a total number of files scanned, a total number of rules checked, a total number of issues found, or a total number of warnings found.

17. The at least one non-transitory computer-readable storage medium of claim 15, wherein the computer-executable instructions further cause the at least one processor to, cause to be displayed, on the user interface, a file containing a specific instance of an error or warning and a description of the specific instance of the error or the warning.

18. The at least one non-transitory computer-readable storage medium of claim 17, wherein the computer-executable instructions further cause the at least one processor to, cause to be displayed, on the user interface, one or more lines of code containing the specific instance of the error or the warning.

19. The at least one non-transitory computer-readable storage medium of claim 15, wherein the computer-executable instructions further cause the at least one processor to scan the source code and determine if the source code contains one or more issues warranting an informational notice.

20. The least one non-transitory computer-readable storage medium of claim 19, wherein the computer-executable instructions further cause the at least one processor to, cause to be displayed, on the user interface, a name of a file containing a specific instance of an informational warning and a description of the specific instance of the informational warning.
